(19) United States
(12) Patent Application Publication
(10) Pub. No.: US 2013/0090866 A1
(43) Pub. Date: Apr. 11, 2013

(54) DIAGNOSTIC METHOD FOR A SOOT SENSOR

(71) Applicants: Johannes Ante, Regensburg (DE); Rudolf Bierl, Regensburg (DE); Markus Herrmann, Regensburg (DE); Andreas Ott, Steinsberg (DE); Willibald Reitmeier, Hohenschambach (DE); Danny Schädlich, Neustadt (DE); Manfred Weigl, Sinzing / Viehhausen (DE); Andreas Wildgen, Nittendorf (DE)

(72) Inventors: Johannes Ante, Regensburg (DE); Rudolf Bierl, Regensburg (DE); Markus Herrmann, Regensburg (DE); Andreas Ott, Steinsberg (DE); Willibald Reitmeier, Hohenschambach (DE); Danny Schädlich, Neustadt (DE); Manfred Weigl, Sinzing / Viehhausen (DE); Andreas Wildgen, Nittendorf (DE)

(73) Assignee: Continental Automotive GmbH, Hannover (DE)

(21) Appl. No.: 13/576,642

(22) PCT Filed: Feb. 1, 2011
(86) PCT No.: PCT/EP2011/051351

§ 371 Date: Dec. 13, 2012

(30) Foreign Application Priority Data
Feb. 2, 2010 (DE) 10 2010 006 708.3

(51) Int. Cl. G01M 15/04; G06F 15/00

(52) U.S. Cl. CPC G01M 15/04; G06F 15/00
USPC 702/35

(57) ABSTRACT

A diagnostic method for a soot sensor that lies in an exhaust gas system of an internal combustion engine. First, a first temperature in the exhaust gas system is detected, and it is determined whether the detected first temperature is below a 100° C. If this is the case, a first measured value is then detected with the soot sensor and compared with a specifiable threshold value. If the first measured value exceeds the specifiable threshold value, the soot sensor is determined to be operating properly.

### CROSS REFERENCE TO RELATED APPLICATIONS

This is a U.S. national stage of application No. PCT/EP2011/051351, filed on 1 Feb. 2011. Priority is claimed on German Application No. 10 2010 006 708.3 filed 2 Feb. 2010, the content of which is incorporated here by reference.

### BACKGROUND OF THE INVENTION

1. Field of the Invention

The present invention relates to a diagnostic method for a soot sensor arranged in an exhaust gas system of an internal combustion engine.

2. Description of Prior Art

Modern motor vehicles with internal combustion engines, in particular motor vehicles with diesel engines, are provided with a particulate filter to prevent the emission of particulate matter, which is detrimental to health and the environment. When the internal combustion engine is in operation, exhaust gas flows through the particulate filter, which filters a majority of the particulate matter out of the exhaust gas. Depending on the operating time of the internal combustion engine or the distance travelled by the motor vehicle, the amount of particulate matter collected in the particulate filter may be so great that the particulate filter starts to clog up. This clogging is detected by a monitoring device comprising various sensors, a control device, and appropriate software. The various sensors are, in particular, differential pressure sensors and temperature sensors. To clean the particulate filter, the control device selects a time and changes the injection conditions such that the exhaust gas temperature is increased. In this way, particulate matter captured in the particulate filter is combusted, known as particulate filter “burn off”. Once this burn-off is complete, the particulate filter is regenerated.

Correct operation of the particulate filter is monitored using a particulate or soot sensor. The soot sensor is intended to establish beyond doubt that the particulate filter is malfunctioning and can then indicate an identified malfunction to a user of the motor vehicle. In addition to soot sensors that measure electrostatically, soot sensors also exist that measure the electrical conductivity of the particulate matter based on resistance. Alternatively, particulate-related dielectric losses may be measured in a suitable capacitor.

DE 10 2006 055 520 A1 discloses a diagnostic method for a soot sensor in an exhaust gas system in which sensor functionality is determined by comparing a measured value of a first electrode system with a measured value of a reference electrode system.

A method and a device for monitoring particulate concentration in a gas stream is described in DE 10 2004 007 634 A1. This document proposes a particulate-collecting sensor in the exhaust gas stream. The sensor is integrated as a capacitive element into an electromagnetic resonant circuit.

A soot sensor is described in DE 10 2005 029 219 A1 that comprises a chip connected to electrical terminals via terminal pads. At least one electrical property of the chip from the group comprising resistance, capacitance, and impedance, is modifiable as a result of exposure to soot.

The above sensors collect soot particles on a small ceramic wafer and measure the change in the electrical properties, for example falling resistance or increasing capacitive losses. Unambiguously associating the electrical measured data from the sensor with the amount of soot is difficult due to other substances that arise in the exhaust gas line.

A disadvantage of the above sensors is that a sensor contaminated with soot cleans itself automatically when the internal combustion engine is operated at full load for a specific period or during particulate filter regeneration due to the elevated exhaust gas temperature. This means that the soot on the sensor surface burns off by itself. A further disadvantage is that in case of recurrent low temperatures, in particular in the case of numerous cold starts and comparatively short full load phases, the sensor may become so heavily contaminated with soot and other substances that meaningful measured values can no longer be obtained with the soot sensor. In this case the sensor is heated to such an extent by a heater so that the soot deposited thereon combusts.

It has been difficult to check the functionality of the soot sensor, since in the case of an intact particulate filter only a few or hardly any soot particles reach the sensor. The reason for this is that the soot sensor for on-board diagnosis (OBD) of the particulate filter is arranged downstream of the particulate filter.

### SUMMARY OF THE INVENTION

An object of one embodiment of the present invention is to provide a diagnostic method for a soot sensor arranged in an exhaust gas system of an internal combustion engine.

A diagnostic method for a soot sensor arranged in an exhaust gas system of an internal combustion engine comprises: detecting a first temperature in the exhaust gas system; determining whether the detected first temperature is below 100° C.; if so: detecting a first measured value with the soot sensor arranged in the exhaust gas system, comparing the first measured value with a specifiable limit value and, if the first measured value exceeds the specifiable limit value, determining that the sensor is operating properly.

A soot sensor is arranged in an exhaust gas system of an internal combustion engine. The internal combustion engine is for example a diesel engine. The exhaust gas system comprises a particulate filter. The soot sensor is arranged downstream of the particulate filter in the direction of exhaust gas flow. The exhaust gas system further comprises at least one temperature sensor. The at least one temperature sensor is preferably arranged between a catalytic converter in the exhaust gas system and the particulate filter or downstream of the particulate filter in the direction of flow. Temperature sensors may likewise be present at both points. The exhaust gas system may further comprise a differential pressure sensor, which detects a pressure difference between a pressure measuring point upstream of the particulate filter in the direction of flow and a pressure measuring point downstream of the particulate filter in the direction of flow. The sensors are connected to a control unit. The control unit analyzes the signals transmitted by the sensors and transmits corresponding control signals to the internal combustion engine.

In a first step of the diagnostic method according to one embodiment of the invention for the soot sensor, a first temperature is detected in the exhaust gas system. It is particularly advantageous for the temperature to be detected in the exhaust gas system in the vicinity of the soot sensor. If the soot sensor is arranged downstream of a particulate filter, a temperature sensor is likewise arranged downstream of the particulate filter.

In a second step, it is determined whether the detected first temperature is below 100° C. If this is the case, then a first measured value is detected with the soot sensor. This detected first measured value is compared with a specifiable limit value in an engine control unit. If the first measured value exceeds the specifiable limit value, it is determined that the sensor is operating properly.

In the method according to one embodiment of the invention, cross-sensitivities of the soot sensor to other substances are used for soot sensor self-diagnosis. The substances used for self-diagnosis should be capable of passing through the intact particulate filter in normal operation. A water fraction contained in the exhaust gas stream is suitable for this purpose. Detection of the first temperature and determination as to whether the first temperature is below 100° C. relates to an internal combustion engine cold start. In this way, the functionality of the soot sensor may undergo a first check on starting of the internal combustion engine of the motor vehicle.

In an advantageous embodiment, the diagnostic method comprises the following further steps: detecting a second temperature in the exhaust gas system; determining whether the detected second temperature is above 100° C.; if so: detecting a second measured value with the soot sensor, comparing the second measured value with a specifiable limit value and, if the second measured value is below the specifiable limit value, determining that the sensor is operating properly.

These further steps improve the diagnostic method according to one embodiment of the invention. This takes into account the fact that a measurement signal resulting from a water fraction in the exhaust gas can no longer occur at a temperature in the exhaust gas system over 100° C.

After an internal combustion engine cold start, the soot sensor outputs a signal in a top third of a measured value range of the soot sensor. The temperature in the exhaust gas system increases as a function of the duration of operation of the internal combustion engine and after a given time exceeds a temperature of 100° C. A soot sensor signal resulting from a water fraction in the exhaust gas can no longer occur once the 100° C. mark has been exceeded.

The following further steps are preferred: detecting a third temperature in the exhaust gas system; determining whether the detected second temperature is above 100° C.; if so: detecting an operating state of the internal combustion engine, detecting a third measured value with the soot sensor, comparing the third measured value with the specifiable limit value and, if the value is below the specifiable limit value, determining that a particulate filter in the exhaust gas system is operating properly or, if the specifiable limit value is exceeded, determining that a particulate filter in the exhaust gas system is defective.

Self-diagnosis of the soot sensor may be used to check the functionality of a particulate filter arranged in the exhaust gas system. If the operating state of the internal combustion engine is full load the soot sensor should output virtually no signal in the case of an intact particulate filter and a temperature of over 100° C. If, however, the soot sensor signal increases or exceeds a specifiable limit value, then soot issues from the particulate filter and the particulate filter is likely defective.

The following further steps are also preferred: identifying a particulate filter burn-off process in the exhaust gas system, detecting a fourth measured value with the soot sensor, comparing the fourth measured value with the specifiable limit value and, if the value exceeds the specifiable limit value, determining that the soot sensor is operating properly.

Using these method steps, self-diagnosis of the soot sensor may be checked during operation of the internal combustion engine, particualarly during relatively extended operation. The soot sensor's high measured value directly after particulate filter burn-off results in particular from the fact that directly after burn-off, a particularly large number of small particles are able to pass through the particulate filter. This leads to a signal increase in the soot sensor.

To further improve the method, a fifth measured value may be detected with the soot sensor after a specifiable time after particulate filter burn-off. The fifth measured value must be below the specifiable limit value for the sensor to be identified as operating properly.

It is particularly advantageous for the diagnostic method of the soot sensor to be performed in a control unit of a motor vehicle with an internal combustion engine, in particular in a motor vehicle with a diesel engine. When the sensor is identified as not operating properly, it either flagged accordingly in the control unit or a signal is output to a user of the motor vehicle. The signal is in particular a visual and/or acoustic signal.

### BRIEF DESCRIPTION OF THE DRAWINGS

The present invention is described in detail below with reference to an exemplary embodiment and to the drawings, in which:

FIG. 1 is a schematic representation of an exhaust gas system of an internal combustion engine; and

FIG. 2 illustrates schematically the procedure involved in a diagnostic method according to one embodiment of the invention for a soot sensor.

### DETAILED DESCRIPTION OF THE PREFERRED EMBODIMENTS

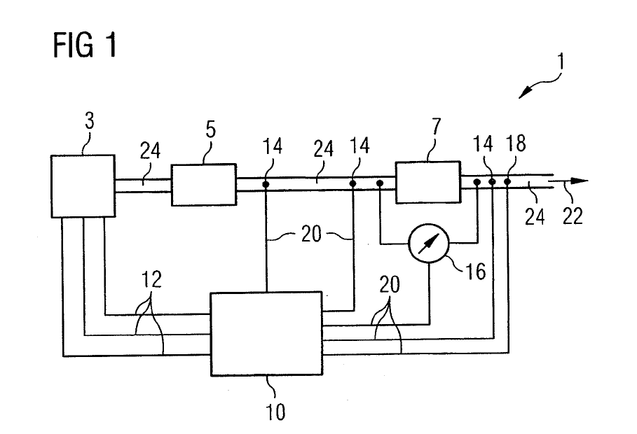

FIG. 1 shows an exhaust gas system 1 of an internal combustion engine 3. The internal combustion engine 3 is, for example, a diesel engine. The exhaust gas system 1 is in particular part of a motor vehicle (not shown). The direction of flow of the exhaust gas out of the internal combustion engine 3 is shown by the arrow 22. An exhaust gas line 24 is arranged on the internal combustion engine 3. The exhaust gas line 24 comprises a catalytic converter 5 and a particulate filter 7 downstream of the internal combustion engine 3 in the direction of flow of the exhaust gas (arrow 22). To control the internal combustion engine 3, a control unit 10 is additionally provided, which is connected to the internal combustion engine 3 by signal lines 12.

Also arranged in the exhaust gas line 24 in the exhaust gas system 1 are a plurality of temperature sensors 14, a differential pressure sensor 16, and a soot sensor 18 . The sensors are each connected to the control unit 10 by signal lines 20. The control unit evaluates the signals transmitted by the sensors 14, 16, and 18 and outputs corresponding control signals to the internal combustion engine 3 via the control signal lines 12.

The temperature sensors 14 are arranged in the exhaust gas line downstream of the catalytic converter 5, upstream of the particulate filter 7 and downstream of the particulate filter 7. The differential pressure sensor 16 comprises one measurement point upstream of the particulate filter 7 and one measurement point downstream of the particulate filter 7. The soot sensor 18 is arranged downstream of the particulate filter 7 in the direction of flow of the exhaust gas (arrow 22).

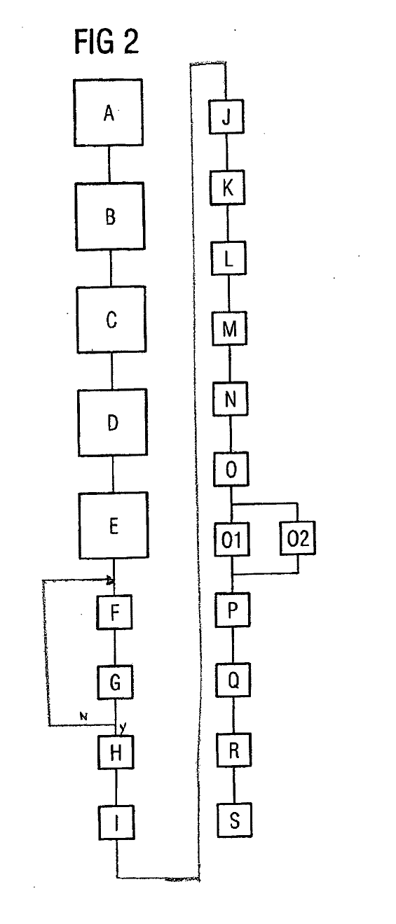

Referring now to FIG. 2, the diagnostic procedure according to the invention for the soot sensor 18 is described. First of all, in a step A, a temperature sensor 14 detects a first temperature in the exhaust gas system 1. The temperature sensor 14 is in particular the sensor arranged adjacent to the soot sensor 18 in the exhaust gas line 24.

In step B, the control unit 10 determines whether the first temperature detected by the temperature sensor 14 is below 100° C. A cold start of the internal combustion engine 3 may be detected in this manner. If the detected temperature is below 100° C., the soot sensor 18 detects a first measured value in step C. In a step D, the control unit 10 compares the first measured value with a specifiable limit value. The specifiable limit value is for example in the middle of the measurement range of the soot sensor or is at two thirds or three-quarters of the measurement range of the soot sensor. If the first measured value exceeds the specifiable limit value, then in step E the control unit 10 determines that the soot sensor is operating properly.

In a step F, a second temperature is detected in the exhaust gas system. This is preferably performed by the same temperature sensor 14, with which the first temperature was also detected. In step G, the control unit 10 determines whether the detected second temperature is above 100° C. If this is the case, then in step H a second measured value is detected with the soot sensor 18. In step I, the control unit 10 compares the detected second measured value with the specifiable limit value and in step J, if the second measured value is below the specifiable limit value, it determines that the soot sensor is operating properly. In particular after a cold start by the internal combustion engine 3 and if the soot sensor 18 has been detected as operating properly in step E, steps F and G are repeated until the temperature in the exhaust gas system is over 100° C.

In step K, a third temperature is detected. In step L, the control unit 10 determines whether the detected third temperature is over 100° C. and then in step M, if the temperature is over 100° C., determines an operating state of the internal combustion engine. If in particular the operating state determined in step M of the internal combustion engine 3 is full load or lies in the upper third of the speed range of the internal combustion engine, in step N a third measured value is detected with the soot sensor 18. In step O, the third measured value is compared with the specifiable limit value. Depending on whether the measured value is below (01) or exceeds (02) the specifiable limit value, the control unit determines that a particulate filter in the exhaust gas system is operating properly (01) or is defective (02).

To further improve the method and also carry out diagnosis of the soot sensor 18 during relatively extended operation of the internal combustion engine 3, in step P a burn-off process of the particulate filter 7 is identified in the exhaust gas system 1. Then in step Q a fourth measured value is detected with the soot sensor 18 and in step R it is compared with the specifiable limit value. If the fourth measured value exceeds the specifiable limit value, then in step S it is determined that the soot sensor 18 is operating properly.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A diagnostic method for a soot sensor arranged in an exhaust gas system of an internal combustion engine, the method comprising:
detecting a first temperature in the exhaust gas system; and
determining if the detected first temperature is below 100° C., and if the detected first temperature is below 100° C.:
detecting a first measured soot value with the soot sensor arranged in the exhaust gas system;
comparing the first measured soot value with a specifiable limit value; and
determining that the soot sensor is operating properly if the first measured soot value exceeds the specifiable limit value.

7. The diagnostic method for a soot sensor as claimed in claim 6, further comprising:
detecting a second temperature in the exhaust gas system; and
determining whether the detected second temperature is over 100° C., and if the detected second temperature is below 100° C.:
detecting a second measured soot value with the soot sensor;
comparing the second measured soot value with the specifiable limit value; and
determining that the soot sensor is operating properly if the second measured soot value is below the specifiable limit value.

8. The diagnostic method for a soot sensor as claimed in claim 7, further comprising:
detecting a third temperature;
determining whether the detected third temperature is over 100° C., and if the detected third temperature is below 100° C.:
determining an operating state of the internal combustion engine;
detecting a third measured soot value with the soot sensor;
comparing the third measured soot value with the specifiable limit value; and one of:
determining that a particulate filter in the exhaust gas system is operating properly if the third measured soot value is below the specifiable limit value and,
determining that a particulate filter in the exhaust gas system is defective if the specifiable limit value is exceeded.

9. The diagnostic method for a soot sensor as claimed in claim 8, further comprising:
identifying a bum-off process of the particulate filter in the exhaust gas system;
detecting a fourth measured soot value with the soot sensor;
comparing the fourth measured soot value with the specifiable limit value; and
determining that the soot sensor is operating properly if the fourth measured soot value exceeds the specifiable limit value.

10. The diagnostic method for a soot sensor as claimed in claim 9, performed in a control unit of a motor vehicle.

11. The diagnostic method for a soot sensor as claimed in claim 10, wherein the motor vehicle has a diesel engine.
